(19) United States
(12) Patent Application Publication
(10) Pub. No.: US 2026/0359706 A1
(43) Pub. Date: Nov. 12, 2026

(54) Dynamic Post-Training Compression of Machine Learning Models Using Auto-Tuned Valuation-Based Pruning

(71) Applicant: Johan Oscar Hallgren, Songdo (KR)

(72) Inventor: Johan Oscar Hallgren, Songdo (KR)

(21) Appl. No.: 19/198,042

(22) Filed: May 3, 2025

(51) Int. Cl. G06N 20/00

(52) U.S. Cl. CPC G06N 20/00

(57) ABSTRACT

This invention enables post-training compression of machine learning models via auto-tuned valuation-based pruning without retraining. The method, Hallgren Value Pruning (HVP), uses a scoring function of the form V═B·O−k·σ to derive layer-wise pruning thresholds, and was derived from a broader Hallgren Unified Valuation Theory (HUVT) framework. It was validated across large language models (LLMs), convolutional networks (CNNs), multilayer perceptrons (MLPs), and random forests (RFs), achieving up to 59.3% parameter reduction with less than 0.3% accuracy drop, and in some cases, improved perplexity. The framework supports dynamic z-score thresholding and auto-tuned pruning strategies using k, offering a model-agnostic, explainable pruning method.

### REFERENCE TO PRIOR APPLICATION

This application claims the benefit of U.S. Provisional Patent Application No. 63/795,615, filed Apr. 27, 2025, titled “Dynamic Post-Training Compression of Machine Learning Models Using Auto-Tuned Valuation-Based Pruning,” the entire contents of which are incorporated herein by reference.

### TECHNICAL FIELD

The present invention relates to systems and methods for post-training optimization and compression of machine learning models. More specifically, it relates to a modular, valuation-driven pruning framework that enables architecture-agnostic, post-training compression without retraining. The invention is applicable, but not limited to, neural networks, ensemble models, convolutional architectures, and transformer-based large language models, and supports efficient deployment in constrained environments such as edge devices, embedded systems, and large-scale distributed inference platforms.

### BACKGROUND

Traditional model compression techniques-such as weight pruning, quantization, and knowledge distillation-often rely on retraining or fine-tuning to recover lost performance after parameter removal. This dependency introduces significant computational costs and complexity, and frequently requires access to original training data, which may not be available in deployment scenarios due to privacy, licensing, or operational constraints.

Moreover, many existing pruning strategies are architecture-specific or rely on hand-crafted heuristics, such as magnitude thresholds or sensitivity metrics, that do not generalize well across different model types. These methods often struggle to scale across large networks and provide little interpretability or control over the compression-performance tradeoff.

Critically, few existing approaches enable post-training, zero-shot pruning-compression applied after training without retraining-while preserving high performance. In addition, current methods rarely offer a unified, interpretable scoring function to assess parameter value across heterogeneous model architectures.

Accordingly, there is a need for a post-training, model-agnostic compression framework that can operate without retraining, while providing an explainable, tunable valuation-based mechanism to identify and prune low-contribution parameters. The invention disclosed herein addresses this gap by introducing a scoring function of the form V═B·O-k·σ, derived from the Hallgren Unified Valuation Theory (HUVT), to support efficient, risk-aware, post-training model pruning applicable to a wide range of architectures, including but not limited to neural networks, convolutional models, and ensemble learning systems.

### SUMMARY OF THE INVENTION

The present invention introduces a general-purpose, post-training pruning method for machine learning models, termed Hallgren Value Pruning (HVP). The method operates without requiring retraining and is based on a valuation function of the form:

V=B·O-k·σ,

where B represents the standalone utility of a model component, O represents its contextual opportunity or relational contribution, σ represents statistical uncertainty or variation, and k is a tunable pruning parameter.

HVP enables automated, valuation-based ranking and removal of low-value components—such as weights, neurons, filters, trees, or tokens—from trained models. It applies dynamic or fixed thresholding strategies using z-score or percentile-based techniques and includes support for automatic tuning of the parameter k to balance compression with task performance.

This method was empirically validated across diverse model classes—including large language models (LLMs), convolutional neural networks (CNNs), multilayer perceptrons (MLPs), and ensemble models such as random forests—demonstrating significant parameter reduction (up to 59.3%) with minimal or no accuracy degradation. In some LLM cases, perplexity improved post-pruning.

The invention is architecture-agnostic, explainable, and suitable for integration into post-training optimization pipelines, deployment workflows, and AutoML systems. It provides interpretable justifications for pruning decisions and is applicable across cloud, edge, embedded, or distributed environments.

### METHOD DEFINITIONS

The present invention introduces a model-agnostic, valuation-based pruning method referred to as Hallgren Value Pruning (HVP). This method enables post-training model compression without retraining by computing a valuation score for each prunable unit or component in a machine learning model and removing those with the lowest scores under a configurable performance constraint.

The method operates using the following valuation scoring function:

V=B×O−k×σ

### Where:

### 1. Base Utility (B)

B represents the standalone or local utility of a model component when evaluated in isolation. It reflects the component's direct contribution to performance, such as accuracy, confidence, or log-likelihood.
In neural models (e.g., MLPs, CNNs, LLMs), B may represent the magnitude or normalized activation of a weight, neuron, or filter.
In ensemble models (e.g., random forests), B is defined as the standalone performance (e.g., accuracy) of an individual tree on the validation set.

### 2. Opportunity Coefficient (O)

O quantifies the contextual or marginal utility of a component when considered within the full model. It reflects how much the component adds to—or could be replaced in—the full system.
In neural models, O may reflect activation relevance, gradient sensitivity, dropout resilience, or redundancy compared to neighboring units.
In ensemble models, O is computed as the relative model performance when the component is excluded. For example, in a random forest, it is the accuracy of the forest without a specific tree divided by the baseline forest accuracy.

### 3. Risk or Uncertainty (σ)

σ represents the standard deviation or variability in the component's utility, used to penalize components that are statistically unstable or inconsistent.
In neural models, o may reflect the variation in activation or gradient across different samples or epochs.
In ensemble models, such as random forests, o is derived via bootstrap resampling to compute the standard deviation in the standalone accuracy of a tree across multiple subsets of the test data.

### 4. Valuation Score (V)

V combines base utility, contextual opportunity, and statistical risk into a single scalar guiding pruning decisions:
A high V score indicates components that should be retained.
A low or negative V score identifies candidates for pruning.

Thresholding strategies may be manually defined (e.g., fixed percentile) or automatically optimized via z-score-based cutoff tuning using the scalar k.

### 5. Pruning Strategies and Auto-Tuning

The system supports:
Static pruning, using a predetermined k value or percentile threshold.
Auto-tuned pruning, where k is iteratively adjusted to identify the most aggressive pruning level that does not exceed a predefined performance drop (e.g., no more than 1% accuracy loss).

Pruning is conducted without retraining and preserves baseline weights or component values for interpretability and reproducibility.

### 6. Applicability Across Model Types

While the present method is demonstrated on neural architectures (including multilayer perceptrons, convolutional neural networks, and large language models) and ensemble classifiers (such as random forests), the valuation-based pruning strategy defined above is not limited to these model classes.

The method is applicable to any parametric or component-based system wherein individual units contribute to aggregate system performance and can be evaluated post hoc in terms of standalone utility, contextual value, and statistical uncertainty. This includes, but is not limited to:
decision trees and rule-based systems,
attention heads and transformer modules,
graph neural networks,
reinforcement learning policies or actors,
symbolic reasoning layers,
probabilistic circuits,
and hybrid systems with decomposable or interpretable substructures.

Accordingly, the Hallgren Value Pruning method generalizes to a broad class of machine learning and optimization architectures, provided they support structured parameterization and measurable per-unit contributions.

### System Architecture

The Hallgren Value Pruning (HVP) method may be implemented within various machine learning system architectures, including standalone model compression tools, training pipelines, or production inference stacks. The architecture is modular, post-training, and compatible with standard model-serving and training environments.

The typical deployment architecture includes the following components:

### 1. Model Interface Layer

This layer provides standardized access to model internals (e.g., weights, neurons, trees, filters) regardless of framework (e.g., PyTorch, TensorFlow, scikit-learn). It extracts prunable components and associated metadata such as shape, magnitude, layer assignment, and role.

### 2. Evaluation Engine

A dynamic benchmarking component that computes the following metrics for each unit:
Standalone utility (B)
Contextual value or impact (O)
Uncertainty or statistical risk (σ)

This engine may operate over a validation set or controlled sampling regime to estimate these component-level metrics, forming the inputs to the pruning valuation function.

### 3. Valuation and Scoring Module

Implements the HVP valuation function:

V=B×O−k×σ

This module supports both:
Static thresholding, using fixed z-score or percentile-based k-values
Auto-tuned pruning, via iterative k-scaling that evaluates pruning outcomes against accuracy or perplexity constraints

The output is a ranked list of components ordered by valuation score. Importantly, all pruning is conducted post-training, without requiring model retraining, gradient updates, or backpropagation.

### 4. Pruning Decision Layer

Executes removal or deactivation of model components according to valuation scores and specified criteria (e.g., prune lowest 25%, or prune until validation loss increases by <1%). This step applies without altering trained model weights through retraining.

Supported pruning granularities include:
Weight level (e.g., dense or convolutional layers)
Neuron or filter level
Tree level (e.g., random forests)
Embedding or token level (e.g., in large language models)

### 5. Post-Pruning Validator

This component evaluates the compressed model against a held-out dataset to verify conformance with performance constraints (e.g., classification accuracy, language model perplexity, latency). If post-pruning results exceed defined tolerances, the system may auto-adjust the pruning threshold k, roll back changes, or raise an alert.

### Deployment Flexibility

The architecture is framework-agnostic and supports:
Offline pruning in post-training pipelines
Real-time pruning on edge devices or model-serving systems
Integration into continuous training or deployment workflows
Exportability to formats like ONNX or TorchScript

### Experimental Results

### Note on Results

The following results are illustrative examples demonstrating the usefulness and applicability of the Hallgren Value Pruning (HVP) method across several model types. These experiments were conducted post-training, without retraining or fine-tuning, using standard public datasets and open-weight models.

While the method consistently showed the ability to improve model efficiency while adequately maintaining or even improving performance, results may vary depending on model architecture, dataset characteristics, and evaluation criteria. The system includes built-in fallback mechanisms to revert or re-tune pruning parameters (e.g., the k coefficient) when performance degradation exceeds user-defined thresholds.

HVP is designed to be model-agnostic and is applicable-but not limited-to neural architectures (e.g., multilayer perceptrons, convolutional neural networks, large language models) and ensemble methods (e.g., random forests). These results demonstrate that Hallgren Value Pruning (HVP) can serve as an effective post-training compression method with minimal or no performance degradation, and in some cases, with actual improvements in generalization metrics such as perplexity. The method is broadly applicable and extensible to other model classes, including transformer architectures, gradient-boosted ensembles, and custom neural or symbolic frameworks, provided the scoring components (B, O, σ) can be defined or estimated.

### Summary of Illustrative Results

| | | Pre- | Post- | | Param |
|---|---|---|---|---|---|
| Model Type | Metric | Pruning | Pruning | Change | Reduction |
| Multilayer | Accuracy | 98.03% | 97.83% | −0.20% | 59.29% |
| Perceptron (MLP) | | | | | |
| Convolutional | Accuracy | 98.03% | 97.83% | −0.20% | 59.29% |
| Neural Net (CNN) | | | | | |
| Large Language | Perplexity | 128.23 | 113.00 | −11.87% | 9.03% |
| Model (LLM)* | | | | (improved) | |
| Random Forest (RF) | Accuracy | 96.49% | 95.91% | −0.58% | 46.00% |

*The LLM result was achieved using the GPT-2 base model (117M parameters) from HuggingFace Transformers, evaluated on the wikitext-2-raw-v1 dataset. The HVP method auto-tuned a pruning parameter of k = 0.090, resulting in a 9.03% parameter reduction and a 11.87% improvement in perplexity, without retraining.

### Datasets Used:

MLP and CNN: MNIST digit classification dataset.
LLM: GPT-2 (117M), tested on the wikitext-2-raw-v1 dataset from HuggingFace.
Random Forest: Breast cancer classification dataset from scikit-learn (load_breast_cancer( )).

These results demonstrate that Hallgren Value Pruning (HVP) can serve as an effective post-training compression method with minimal or no performance degradation, and in some cases, with actual improvements in generalization metrics such as perplexity.

### Advantages Over Prior Art

The Hallgren Value Pruning (HVP) method introduces a novel, valuation-driven approach to post-training model compression that resolves several limitations inherent in prior art.

Compared to existing pruning and compression techniques, HVP offers the following key advantages:

### 1. No Retraining Required

Unlike most pruning approaches that require retraining or fine-tuning to recover performance after parameter removal, HVP is designed to operate entirely post-training, without backpropagation, gradient updates, or re-optimization. This significantly reduces computational overhead and simplifies deployment in constrained environments.

### 2. Valuation-Based Decision Logic

Traditional pruning methods rely on magnitude thresholds, sparsity heuristics, or empirical importance scores. HVP uses a formal, interpretable scoring function:

V=B·O−k·σV=B·O−k·σV=B·O−k·σ

where BBB is standalone utility, OOO is contextual or relational opportunity, and σσσ is statistical uncertainty. This enables explainable and context-sensitive pruning decisions across model types.

### 3. Auto-Tuned Compression Strategy

The method supports automatic selection of the pruning parameter kkk based on user-defined performance constraints (e.g., maximum allowable drop in accuracy or increase in perplexity). This eliminates the need for manual hyperparameter tuning and enables adaptive compression in real-world deployments.

### 4. Model-Agnostic and Universally Applicable

HVP has been successfully applied to a wide range of architectures, including multilayer perceptrons (MLPs), convolutional neural networks (CNNs), large language models (LLMs, e.g., GPT-2), and ensemble methods such as random forests. The method is compatible with both neural and non-neural models, and can be extended to additional domains where valuation components can be defined.

### 5. Explainability and Interpretability

By framing pruning as a value-optimization decision, HVP provides transparent justifications for which components are removed and why. Each pruning action can be traced back to its valuation score, making the method suitable for regulated industries where model explainability is critical.

6. Compatible with Standard ML Frameworks

HVP can be implemented in common machine learning libraries such as PyTorch,

1. A post-training machine learning model compression method comprising:
(a) computing, for each component within a trained model, a valuation score defined by the formula V=B·O−k·σ, where:
(i) B represents the standalone utility of the component;
(ii) O represents its contextual opportunity or relational contribution;
(iii) σ represents statistical uncertainty or variation; and
(iv) k is a tunable pruning parameter;
(b) ranking said components based on their valuation scores;
(c) removing or deactivating components falling below a valuation threshold derived from the pruning parameter k;
(d) evaluating the pruned model to ensure performance metrics remain within predefined degradation limits; and
(e) wherein the method is performed without need for retraining the model.

2. A system for valuation-based post-training pruning of machine learning models, comprising:
(a) a model interface layer configured to extract internal components and metadata from a trained model, including weights, filters, neurons, or decision trees;
(b) an evaluation engine configured to compute, for each component, a standalone utility score (B), a contextual opportunity score (O), and a measure of uncertainty (σ) based on task-relevant data;
(c) a valuation and scoring module configured to calculate a pruning score for each component using the function: V=B·O−k·σ, where k is a pruning parameter;
(d) a pruning decision module configured to remove or deactivate components with scores below a threshold determined by k or by percentile rank;
(e) a validation module configured to evaluate the pruned model on held-out data and confirm that performance remains within a defined tolerance range; and
(f) wherein the system performs pruning without retraining the model.

3. The method of claim 1, further comprising: selecting a set of candidate values for the pruning parameter k; computing valuation scores using the function V=B·O−k·σ for each candidate; pruning the corresponding components; evaluating performance on validation data; and selecting the value of k that maximizes parameter reduction while maintaining acceptable performance.

4. The method of claim 1, wherein the model is a neural network, and the components subject to pruning include one or more of: individual weights, neurons, filters, or attention heads.

5. The method of claim 1, wherein the model is an ensemble model, and the components subject to pruning include one or more of: individual decision trees, decision paths, or feature-based splits.

6. The method of claim 1, wherein the trained model is selected from any of: neural networks, ensemble methods, probabilistic models, rule-based systems, or hybrid architectures.

7. The method of claim 1, wherein the contextual value (O) is computed based on one or more of: inter-layer activation dependencies, inter-neuron correlations, attention relevance, feature importance, or task-specific contribution estimated from validation data.

8. The method of claim 1, wherein the standalone utility (B) of each component is computed based on one or more of: absolute weight magnitude, activation contribution, individual error reduction, or unit-level relevance on validation tasks.

9. The method of claim 1, wherein the uncertainty term (σ) is computed using one or more of: variance across validation samples, dropout-induced variability, gradient sensitivity, inter-feature entropy, or statistical deviation from baseline activations.

10. The method of claim 1, wherein pruning is applied at one or more of the following levels: individual weights, neurons, filters, attention heads, decision trees, embedding vectors, or token mappings.

11. The method of claim 1, further comprising reverting or adjusting pruning decisions if the pruned model's performance exceeds a predefined degradation threshold on validation data.

12. The method of claim 1, wherein the pruning is performed as a post-training operation integrated into a model deployment pipeline, training workflow, or automated machine learning (AutoML) system.

13. The method of claim 1, wherein the valuation function and pruning process are applicable across different model architectures without requiring modification of the model's training procedure, internal structure, or learning algorithm.

14. The method of claim 1, wherein the valuation scores used for pruning provide interpretable justifications for each component's removal or retention, enabling transparent analysis of model compression effects.

15. The method of claim 1, wherein the pruning process is applied to reduce model size and inference load for deployment in performance-sensitive environments, including edge devices, embedded systems, cloud infrastructure, or distributed computing platforms.

16. The method of claim 1, wherein the valuation score function V may alternatively be expressed using parameterized or weighted formulations, including but not limited to: V=α·B·O−k·σ, or V=B−k·σ, to accommodate domain-specific adjustments or simplified approximations.

17. The method of claim 1, wherein the pruning is applied to hybrid or multi-modal models comprising multiple sub-architectures, including but not limited to combinations of convolutional networks, transformers, tree ensembles, or embedding modules.
